(19) United States
(12) Patent Application Publication
(10) Pub. No.: US 2020/0088284 A1
(43) Pub. Date: Mar. 19, 2020

(54) GEAR ASSEMBLY HAVING A GEAR COMPRISING A FIRST POLYMER AND A BUSHING COMPRISING A SECOND POLYMER

(71) Applicant: BorgWarner Inc., Auburn Hills, MI (US)

(72) Inventors: Joseph Hahn, Clawson, MI (US); Ian Bartusch, Sterling Heights, MI (US)

(21) Appl. No.: 16/132,562

(22) Filed: Sep. 17, 2018

(51) Int. Cl. F16H 55/06; F02B 39/00; F16H 19/00

(52) U.S. Cl. CPC F16H 55/06; F16H 2055/065; F16H 19/001; F02B 39/00

(57) ABSTRACT

A gear assembly rotates about a pin in an actuator. The gear assembly includes a gear. The gear includes a gear body including a first polymer surrounding and extending radially away from a rotational axis. The gear body has an internal surface that defines a bore along and about the rotational axis. The gear further includes a plurality of teeth extending from the gear body. The gear assembly further includes a bushing including a second polymer, different than the first polymer. The bushing is disposed within the bore. One of the bushing and the gear body is overmolded to the other one of the bushing and the gear body along the internal surface. The bushing has a bearing surface defining a hole along and about the rotational axis for rotatably engaging the bearing surface with the pin in the hole.

### BACKGROUND OF THE INVENTION

### 1. Field of the Invention

The present invention relates to a gear assembly having a gear comprising a first polymer and a bushing comprising a second polymer.

### 2. Description of Related Art

Many devices in vehicles, such as a turbochargers and exhaust gas recirculation (EGR) valves, use an actuator to control their functions and performance. For example, in certain actuators, pneumatic and electric actuators are used to provide positional control of variable vanes of a turbocharger or a valve plate of an EGR valve to adjust and maintain fluid pressure and fluid flow within an intake manifold of an engine. Controlling the fluid pressure and the fluid flow within the intake manifold provides optimum performance while maintaining legislated vehicle emissions.

Traditionally, the actuator includes a gear drive assembly which transmit motion to the device. The gear drive assembly provides a plurality of gears which collectively interact to provide a velocity and a torque to the device for moving the device. The gear drive assembly typically has a plurality of gears made of metal or plastic. For those actuators using all metal gears, the gears are typically supported by a ball bearing or a needle bearing system at each driven gear, which are larger and more costly. Plastic gears have been directly molded to shafts that are supported by a bearing underneath the gear within the housing. The spacing of the plastic gear from the bearing creates a cantilever effect on the bearing from the load applied to the plastic gear, which increases friction and wear on the bearing. As such, there remains a need to provide an improved gear for a gear drive assembly

### SUMMARY OF THE INVENTION

The present invention provides a gear assembly for rotation about a pin in an actuator. The gear assembly comprises a gear. The gear comprises a gear body comprising a first polymer surrounding and extending radially away from a rotational axis. The gear body has an internal surface that defines a bore along and about the rotational axis. The gear further comprises a plurality of teeth extending from the gear body.

The gear assembly further comprises a bushing comprising a second polymer, different than the first polymer. The bushing is disposed within the bore. One of the bushing and the gear body is overmolded to the other one of the bushing and the gear body along the internal surface. The bushing has a bearing surface defining a hole along and about the rotational axis for rotatably engaging the bearing surface with the pin in the hole.

Accordingly, in the present invention the overmolding of one of the bushing and the gear body to the other one of the bushing and the gear body provides the advantage of direct contact between the first and second polymers along the entire interface of the materials due to the material flowing into and filling voids therebetween. The direct contact between the materials along the entire interface of the materials increases friction between the materials and promotes a bond between the materials. As such, the overall complexity of the gear assembly is reduced by eliminating the need for tight tolerances between the bushing and the gear and eliminating deflection of the bushing due to draft angles in the bore that occur when a bushing comprised of a polymer is press-fit into another component. The bushing and the gear are simply molded into direct contact with one another.

The present invention provides further advantages in that the use of the first and second polymers for the gear and the bushing, respectively, reduces weight and cost and reduces the number of manufacturing steps compared to traditional metal gears that often require additional machining and steps to press-fit a bushing or a bearing into the bore

### BRIEF DESCRIPTION OF THE DRAWINGS

Advantages of the subject invention will be readily appreciated as the same becomes better understood by reference to the following detailed description when considered in connection with the accompanying drawings.

FIG. 1 is a schematic view of an actuator, according to the present invention, used with an engine, an intake manifold, an exhaust manifold, and a turbocharger.

FIG. 2 is a perspective view of the actuator of FIG. 1 showing a housing and an output shaft.

FIG. 3 is a perspective view of the actuator of FIG. 1 showing a motor and a gear drive assembly having a gear assembly.

FIG. 4 is a perspective view of a valve for use with the actuator of FIG. 1.

FIG. 5 is a cross-sectional view of the gear assembly taken along line 5-5 of FIG. 3.

FIG. 6 is a perspective view of the gear assembly of FIG. 3 showing a second pin.

FIG. 7 is a top elevational view of the gear assembly of FIG. 6.

FIG. 8 is a bottom elevational view of the gear assembly of FIG. 6.

FIG. 9 is a perspective view of a gear assembly showing a bushing and a shaft of a shaft assembly.

FIG. 10 is a top elevational view of the gear assembly of FIG. 9.

FIG. 11 is a bottom elevational view of the gear assembly of FIG. 9.

FIG. 12 is a cross-sectional perspective view of the gear assembly taken along line 12-12 of FIG. 9.

FIG. 13 is a perspective view of the shaft assembly and the bushing of FIG. 9.

FIG. 14 is a top elevational view of the shaft assembly and the bushing of FIG. 13.

### DETAILED DESCRIPTION OF THE INVENTION

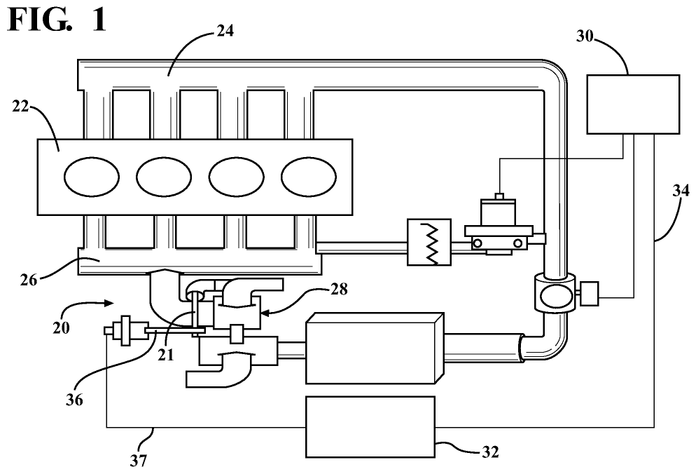

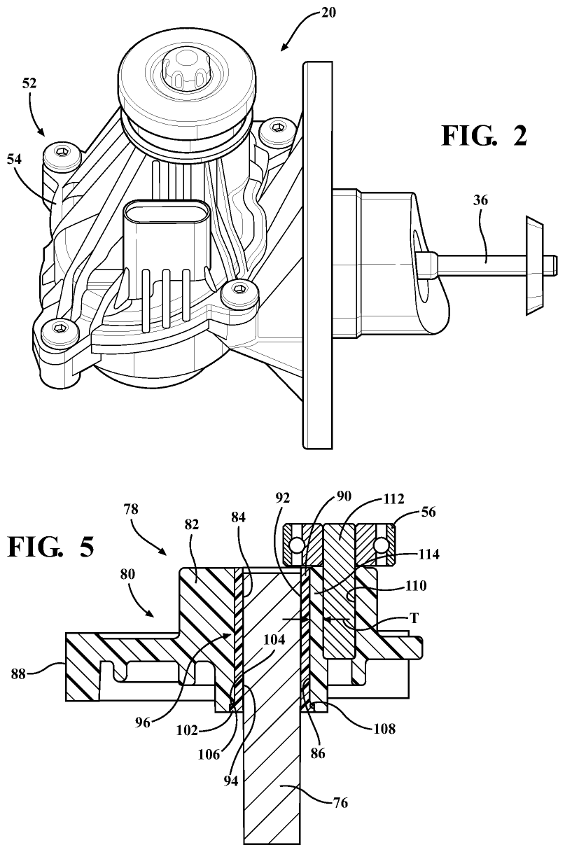

Referring to the Figures, wherein like numerals indicate like or corresponding parts throughout the several views, an actuator 20 is generally shown in FIG. 1. The actuator 20 is typically used for controlling a control shaft 21 within a vehicle. In one example, the control shaft 21 controls the flow of a fluid to or from an engine 22 of the vehicle. As shown schematically in FIG. 1, the vehicle may include the engine 22, an intake manifold 24 configured to flow air into the engine 22, and an exhaust manifold 26 configured to flow exhaust out of the engine 22. In one embodiment, the control shaft 21 is used in a turbocharger 28 which is fluidly coupled with each of the intake manifold 24 and the exhaust manifold 26 to increase flow of the air into the engine 22 by way of utilizing the energy of the moving exhaust flowing out of the engine 22, as is commonly known to those having ordinary skill in the art. The actuator 20 is positioned between the exhaust manifold 26 and the turbocharger 28, with the actuator 20 controlling a position of the turbocharger 28 through the control shaft 21, which in-turn controls the pressure and the flow of the air into the engine 22 through the intake manifold 24 and is commonly referred to as boost pressure. It should be appreciated that the actuator 20 may be used for controlling a mechanical device that shifts gears, lifts tailgates, lifts windows, etc.

The vehicle may further include an electronic control unit (ECU) 30 and an actuator controller 32. The ECU 30 may be connected to the actuator controller 32 by a wire harness 34 having multiple conductors and connectors. The actuator controller 32 may also be connected to the actuator 20 by a wire harness 37 having multiple conductors and connectors. For this illustration, the actuator controller 32 is shown as separate component. However, one having ordinary skill in the art will appreciate that the actuator controller 32 may be integrated within the actuator 20 or the ECU 30.

The ECU 30 may provide an electrical position input signal to the actuator controller 32 that may indicate a desired position of the control shaft 21 as controlled by the actuator 20. The actuator controller 32 may provide the necessary electrical control signal to the actuator 20 to achieve the desired position of the control shaft 21.

The actuator 20 may also provide feedback in the form of an electrical position output signal to the actuator controller 32. A “closed loop” control scheme may be used to maintain a desired position of the control shaft 21 as controlled by the actuator 20 by comparing the feedback electrical position output signal value to a desired value and may adjust the electrical control signal to the actuator 20 to maintain the resulting position of the control shaft 21 and the resultant fluid flow and boost pressure. Although the actuator 20 is shown in FIG. 1 controlling a position of the turbocharger 28, one having ordinary skill in the art will appreciate that the actuator 20 may be used anywhere within vehicles for controlling the flow of a fluid to or from an engine 22, such as with an exhaust gas recirculation (EGR) valve, a throttle fluidly coupled to an intake manifold 24, waste gates, exhaust throttles, etc.

The actuator 20 also includes an output shaft 36, movable between a plurality of positions. The output shaft 36 may be coupled to the control shaft 21 of the turbocharger 28, as described above. The turbocharger 28 may include a turbine fluidly coupled with the exhaust manifold 26 and a compressor fluidly coupled with the intake manifold 24. The turbine may have a plurality of vanes. The movement of the control shaft 21 by the movement of the output shaft 36 may vary the orientation of the vanes to alter the flow of the fluid past the turbine, which in-turn alters the pressure and the flow of the fluid from the compressor into the intake manifold 24.

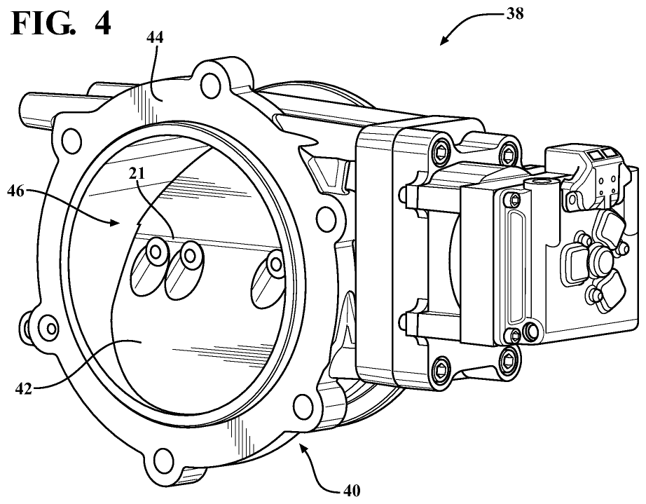

In another embodiment, the control shaft 21 may be used in a valve 38. The output shaft 36 may be coupled to the control shaft 21 of the valve 38, as shown in FIG. 4. Movement of the output shaft 36 between the plurality of positions may move the control shaft 21 of the valve 38 between a plurality of positions. The valve 38 may be further defined as a butterfly valve 40. The butterfly valve 40 may include a plate 42 coupled to the control shaft 21 and pivotally disposed within a valve housing 44 defining a bore 46, with the plate 42 capable of changing the cross-sectional area of the bore 46 between the plurality of positions to alter the flow of the fluid. One having ordinary skill in the art will appreciate that the valve 38 may be any particular valve capable of controlling the flow of a fluid, such as a poppet valve, a flap valve, or a ball valve.

The plurality of positions of the control shaft 21 of the valve 38 may include a fully open position and a fully closed position. When the control shaft 21 of the valve 38 is in the fully open position, the valve 38 induces the least amount of restriction to the flow of the fluid. When the control shaft 21 of the valve 38 is in the fully closed position, the valve 38 induces the greatest amount of restriction to the flow of the fluid. The greatest amount of restriction to the flow of the fluid may result in complete stop of fluid flow. The plurality of positions may include at least one intermediate position between the fully open position and the fully closed position capable of partially restricting the flow of the fluid. One having ordinary skill in the art will appreciate that the plurality of positions of the control shaft 21 of the valve 38 may be any number of positions and any type of position to create a desire fluid flow. One having ordinary skill in the art will appreciate that the actuator 20 may be configured to actuate any suitable component through the rotation of the output shaft 36.

As such, the actuator 20 may be configured to meet desired velocity and torque characteristics of the output shaft 36. The actuator 20 may be capable of having first and second outputs. It is to be appreciated that the actuator 20 may be configured to have any number of suitable outputs.

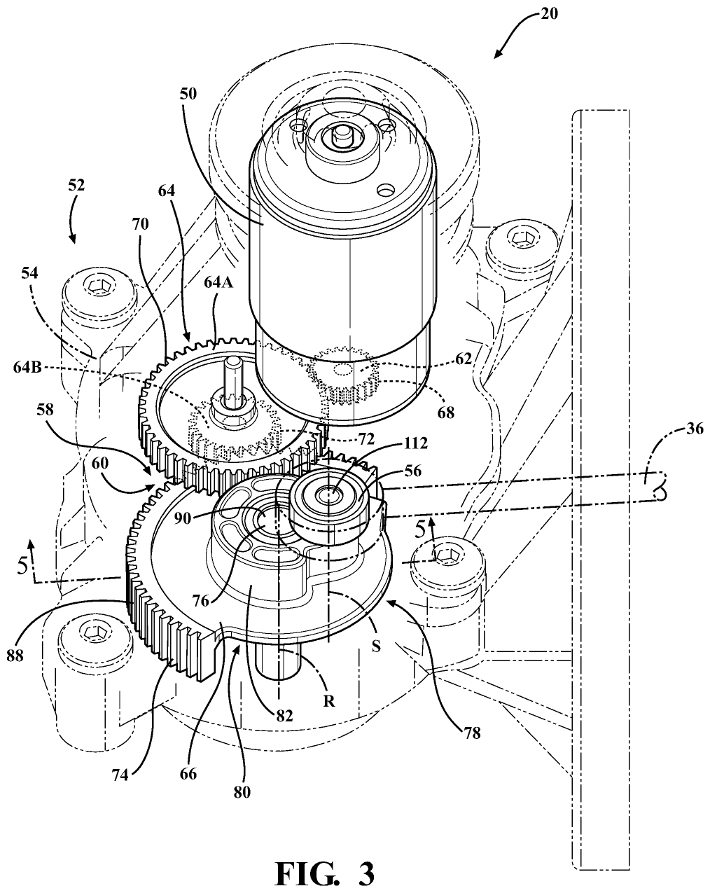

Furthermore, the actuator 20 may produce rotary or linear motion. For illustrative purposes, the actuator 20 shown in the Figures produces linear motion. The actuator 20 includes a motor 50 as shown in FIG. 3. The motor 50 may be a direct current (D.C.) motor 50. The D.C. motor 50 may or may not include brushes to produce motion. The motor 50 may be configured to be controlled by an electrical control signal. More specifically, at least one of the ECU 30 and the actuator controller 32 control the motor 50 (and, moreover, the actuator 20) by the electrical control signal. One having ordinary skill in the art will appreciate that the motor 50 and the actuator 20 may be controlled by any suitable mechanism, such as a mechanical switch.

As illustrated in FIG. 3, the actuator 20 further includes a gear drive assembly 52, according to one embodiment of the present invention, for use with and driven by the motor 50 of the actuator 20. The gear drive assembly 52 includes a housing 54 defining a cavity 58. The gear drive assembly 52 may further include a gear arrangement 60, generally indicated at 60, disposed in the cavity 58. In one embodiment, the gear arrangement 60 includes a drive gear 62 and at least two driven gears including a first driven gear 64 and a second driven gear 66.

The motor 50 may have a shaft rotatable about a shaft axis and capable of transmitting rotational force with the shaft. The shaft may extend through the housing 54 and may be at least partially disposed in the cavity 58, with the drive gear 62 operably coupled with the shaft. Furthermore, the drive gear 62 may be fixed to and rotatable with the shaft about the shaft axis. As such, the drive gear 62 is fixed to the shaft such that motion of the shaft is imparted directly to the drive gear 62. One having ordinary skill in the art will appreciate that the drive gear 62 may be coupled to the shaft in any suitable way.

As illustrated in FIG. 3, the drive gear 62 may have a plurality of gear teeth 68 extending radially and defining an input diameter of the drive gear 62. The drive gear 62 may have a substantially circular configuration. As such, the drive gear 62 may be referred to as a spur gear. Furthermore, the drive gear 62 may be comparatively smaller than the first driven gear 64 and the second driven gear 66. As such, the drive gear 62 may be referred to as a pinion gear. One having skill in the art will appreciate that the drive gear 62 may have any suitable gear configuration, such as a bevel gear configuration.

The first driven gear 64 may have a first gear section 64A and a second gear section 64B. Furthermore, the first driven gear 64 may have a plurality of gear teeth 70 on the first gear section 64A extending radially and defining an output diameter of the first driven gear 64. The first driven gear 64 may have a plurality of gear teeth 72 on the second gear section 64B extending radially. Furthermore, the first driven gear 64 may have the second gear section 64B spaced from and fixed to the first gear section 64A. Both of the first and second gear sections 64A, 64B may have a substantially circular configuration. As such, the first driven gear 64 may be referred to as two spur gears. In addition, the first and second gear sections 64A, 64B may be fixed to one another such that the first and second gear sections 64A, 64B rotate in unison about an axis. As such, the first driven gear 64 may be referred to as a compound gear. One having ordinary skill in the art will appreciate that the first driven gear 64 may have any suitable gear configuration, such as a bevel gear configuration.

The second driven gear 66 of the gear arrangement 60 may have a plurality of gear teeth 74 extending radially and defining an output diameter of the second driven gear 66. As shown in FIG. 3, the second driven gear 66 may have a substantially semi-circular configuration. As such, the second driven gear 66 may be referred to as a half spur gear. The second driven gear 66 may be rotatably coupled to the housing 54 about an axis and may be operably coupled with the output shaft 36. In the embodiment shown in FIG. 3, the gear drive assembly 52 includes a bearing 56 coupled to the second driven gear 66 and spaced from the axis. The output shaft 36 may be at least partially disposed in the cavity 58 and coupled to the bearing 56. The output shaft 36 may extend through the housing 54. Because the bearing 56 is offset from the axis, the bearing 56 moves along a path around the axis as the second driven gear 66 rotates. Furthermore, rotation of the second driven gear 66 causes longitudinal translation of the output shaft 36. Accordingly, the second driven gear 66 is commonly referred to in the art as an eccentric gear. However, one having ordinary skill in the art will appreciate that the at least one second driven gear 66 may have any suitable gear configuration, such as a complete spur gear or a bevel gear configuration.

The gear teeth 70 of the first gear section 64A of the first driven gear 64 may be engageable with the gear teeth 68 of the drive gear 62 to define a first gear stage. The gear teeth 72 of the second gear section 64B of the first driven gear 64 may be engageable with the gear teeth 74 of the second driven gear 66 to define a second gear stage.

The operation of transmitting rotation from the motor 50 to the longitudinal translation of the output shaft 36 in accordance with the embodiment shown in the Figures is described below for illustrative purposes. One having ordinary skill in the art will appreciate that, although not expressly recited herein, numerous operations are possible in accordance with the present invention.

When the motor 50 is activated, the motor 50 rotates the shaft about the shaft axis. The shaft is coupled to the drive gear 62, which causes the drive gear 62 to rotate about the axis. The drive gear 62 engages the first gear section 64A of the first driven gear 64 at the first stage, which causes the first driven gear 64 to rotate about its axis. The first gear section 64A and the second gear section 64B of the first driven gear 64 are fixed to one another. As such, rotation of the first gear section 64A results in simultaneous rotation of the second gear section 64B.

The second gear section 64B of the first driven gear 64 engages the second driven gear 66, at the second stage, which causes the second driven gear 66 to rotate about its axis. The second driven gear 66 is coupled to the output shaft 36 through the bearing 56, which causes the output shaft 36 to longitudinally translate between the plurality of positions.

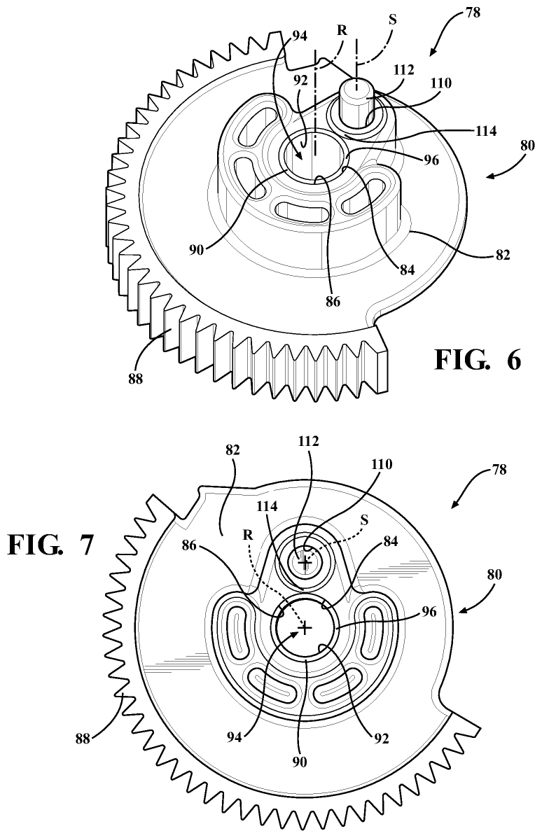

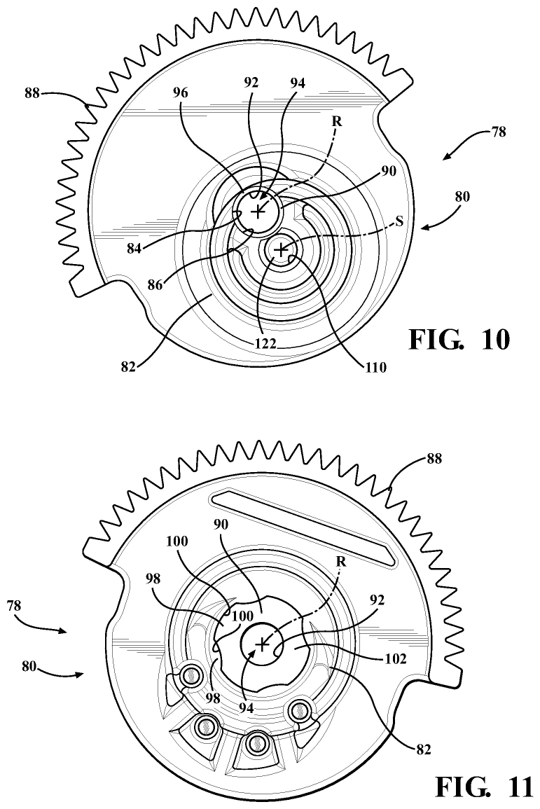

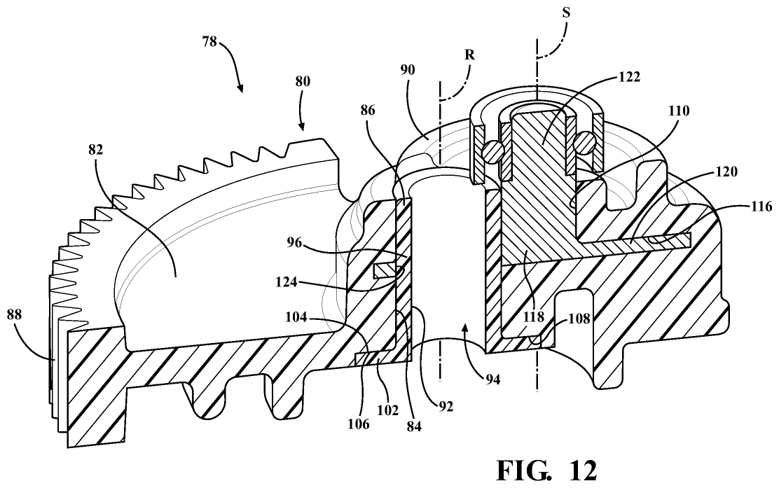

As shown in FIG. 3, the gear drive assembly 52 further includes a pin 76 disposed in the cavity 58 and coupled to the housing 54 and a gear assembly 78 rotatable about the pin 76. As shown in FIGS. 5-12, the gear assembly 78 comprises a gear 80. The gear 80 comprises a gear body 82 comprising a first polymer surrounding and extending radially away from a rotational axis R. As shown in FIGS. 5 and 12, the gear body 82 has an internal surface 84 that defines a bore 86 along and about the rotational axis R. The gear 80 further comprises a plurality of teeth 88 extending from the gear body 82. The plurality of teeth 88 may extend radially away from the rotational axis R.

The gear assembly 78 further comprises a bushing 90 comprising a second polymer, different than the first polymer. The bushing 90 is disposed within the bore 86. One of the bushing 90 and the gear body 82 is overmolded to the other one of the bushing 90 and the gear body 82 along the internal surface 84. The bushing 90 has a bearing surface 92 defining a hole 94 along and about the rotational axis R for rotatably engaging the bearing surface 92 with the pin 76 in the hole 94.

In the embodiment shown in FIG. 3, the gear assembly 78 is shown as the second driven gear 66. However, the gear assembly 78 may be associated with the drive gear 62, the first driven gear 64, or any other suitable gear not explicitly shown or disclosed herein.

The bushing 90 supports the gear 80 and interfaces with the pin 76. As shown in FIGS. 6-11, the internal surface 84 of the gear body 82 and the bushing 90 may each have corresponding substantially cylindrical configurations. As such, the bushing 90 abuts against and frictionally engages a substantial portion of the internal surface 84. Furthermore, the bearing surface 92 of the bushing 90 and the pin 76 may each have corresponding substantially cylindrical configurations. The gear 80 and the bushing 90 rotate as unit around the pin 76. More specifically, the bearing surface 92 and the pin 76 are sized to facilitate movement of the bearing surface 92 along the pin 76.

As described above, one of the bushing 90 and the gear body 82 is overmolded to the other one of the bushing 90 and the gear body 82. Overmolding is the process of molding one material against another dissimilar material. The one or more of the materials may be a liquid, with the molding process being performed by injection molding, extrusion, or the like. Accordingly, during the molding process the contact between the materials may occur when one or more of the materials is a liquid and one or more of the material is a solid. Furthermore, the contact between the materials may occur when all of the materials are a liquid. The molding of the liquid material against another liquid or a solid material allows for liquid material flow into and fill voids between the materials, which promotes direct contact between the materials along the entire interface of the materials. The direct contact between the materials along the entire interface of the materials increases friction between the materials and promotes a bond between the materials.

Overmolding provides further advantages over press-fitting the bushing 90 into the bore 86 of the gear 80. When press-fitting a bushing into a component having a bore, the coupling between the bushing and the component is effected by the size of the bore in relation to the size of the bushing. The bore often has a maximum bore diameter tolerance that is relatively small. One non-limiting example of a maximum bore diameter tolerance is 0.012 mm. This tolerance is difficult to achieve using polymers. Furthermore, the component will have a molding draft angle within the bore as a result of polymer molding processes. Pressing the bushing into the drafted bore would cause the bushing, in turn, to become conical in shape, which negatively effects the fit and function between the bushing and the pin. The bore may be machined to remove the draft angle; however, machining a polymer breaks the polymer chains which can lead to stress risers in the material. As a result, meeting the required tolerance to facilitate press-fitting the bushing leads to high costs, scrap, and post machining processes.

When overmolding is utilized, these press-fitting scenarios are avoided. The overall complexity of the component is reduced by eliminating the need for tight tolerances in the polymer part and eliminating any concern of draft angles in the bore 86 that the bushing 90 presses into when press-fitting. The bushing 90 and the component (i.e., the gear 80) are simply molded into direct contact with one another. Additionally, overmolding allows for the easy integration of an anti-rotation feature onto the bushing 90 (described in greater detail below) which ensures the bushing 90 does not rotate within the component (i.e., the gear 80). Anti-rotation features are difficult to integrate into the bushing 90 when press-fitting is performed because the anti-rotation feature must be precisely aligned during the entire pressing operation. The anti-rotation feature prevents the bushing 90 from loosening from the component over time and rotating within the bore 86, causing increased wear and friction and overall reduced performance.

In one embodiment the gear body 82 is overmolded to the bushing 90. In another embodiment, the bushing 90 is overmolded to the gear body 82.

A wide variety of polymers are suitable for use as the first polymer of the gear 80. The first polymer may comprise a polyamide. Examples of suitable polyamides include, but are not limited to, nylon 6 or nylon 6/6. However, it should be understood that other polymers may also be used as the first polymer. In the context of the present invention and as described above, it is to be understood the first polymer may be a neat, i.e., virgin, uncompounded resin, or the first polymer may be an engineered product where the polymer is compounded with other components, for example with select additives (fillers, fibers, etc.) to improve certain physical properties. As one example, the gear assembly 78 may further comprise a glass fiber that is dispersed within the first polymer. The glass fiber reinforces the first polymer to improve the strength of the gear 80. One non-limiting example of the glass fibers dispersed with the first polymer is Stanyl®—PA46. However, the first polymer may be any suitable polymer material from which the gear 80 may be formed.

The second polymer may have characteristics which facilitate even wear of the bearing surface 92 during the life of the bushing 90. For example, the second polymer may comprise a thermoset which will remain in a solid phase under high-heat and friction. One non-limiting example of a bushing 90 comprising a material with such characteristics is the IGlide H4 produced by IGUS. However, the second polymer may be any suitable material from which the bushing 90 may be formed.

As shown in FIGS. 5 and 12, the bushing 90 may comprise a wear region 96 between the bearing surface 92 and the internal surface 84 of the gear body 82. The wear region 96 may comprise only the second polymer to facilitate even wear of the bushing 90 as the gear assembly 78 rotates about the pin 76. Furthermore, the wear region 96 may have a uniform thickness about the rotational axis R. The uniform thickness prevents localized portions of the bushing 90 from wearing through and exposing the first polymer to the friction of the pin 76.

The present invention provides further advantages in that the use of the first and second polymers for the gear 80 and the bushing 90, respectively, reduces weight and cost and reduces the number of manufacturing steps compared to traditional metal gears that often require additional machining and steps to press-fit a bushing 90 or a bearing into the bore 86.

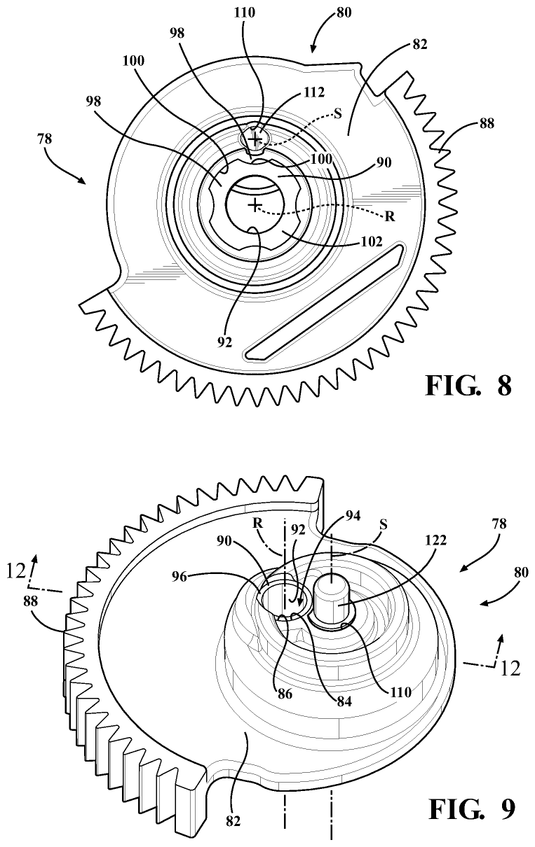

As shown in FIGS. 8 and 11, one of the gear body 82 and the bushing 90 may have a protrusion 98 extending radial to the rotational axis R and the other one of the gear body 82 and the bushing 90 may define a recess 100 configured to receive the protrusion 98 to rotationally retain together the gear body 82 and the bushing 90 about the rotational axis R. Said differently, when the protrusion 98 is defined by the gear body 82, the protrusion 98 abuts against the portion of the bushing 90 that defines the recess 100 if the gear body 82 rotates about the rotational axis R independent of the bushing 90 Likewise, when the protrusion 98 is defined by the bushing 90, the protrusion 98 abuts against the portion of the gear body 82 that defines the recess 100 if the gear body 82 rotates about the rotational axis R independent of the bushing 90. The abutment between the bushing 90 and the gear body 82 as facilitated by the disposition of the protrusion 98 within the recess 100 provides a force opposing the independent rotation of the gear body 82 and the bushing 90, which rotationally retain together the gear body 82 and the bushing 90 about the rotational axis R.

The protrusion 98 may have a convex arcuate configuration and the recess 100 may have a corresponding concave arcuate configuration. The corresponding convex and concave arcuate configurations ensure even and continuous contact between the gear body 82 and the bushing 90 (i.e., no voids). However, the protrusion 98 and the recess 100 may have configurations that do not correspond to another (i.e., the gear body 82 and the bushing 90 may be spaced from one another within the recess 100) while still facilitating engagement between the gear body 82 and the bushing 90 during independent rotation of the gear body 82 and the bushing 90 about the rotational axis R. Furthermore, the protrusion 98 and the recess 100 may have any suitable shape (such as an angular geometric shape) while still facilitating engagement between the gear body 82 and the bushing 90 during independent rotation of the gear body 82 and the bushing 90 about the rotational axis R.

The protrusion 98 may be further defined as a plurality of protrusions 98 and the recess 100 may be further defined as a plurality of recesses 100 individually corresponding with the plurality of protrusions 98. The plurality of protrusions 98 and the recesses 100 distribute the load between the gear body 82 and the bushing 90 around the rotational axis R to reduce stress-risers from propagating in the first and/or second polymers at locations of high loading. Furthermore, each of the gear body 82 and the bushing 90 may have one (or more) of the plurality of protrusions 98 radially spaced about the rotational axis R and each of the gear body 82 and the bushing 90 may define one (or more) of the plurality of the recesses 100 radially spaced about the rotational axis R. The recess 100 of the bushing 90 may be configured to receive the protrusion 98 of the gear body 82 and the recess 100 of the gear body 82 may be configured to receive the protrusion 98. Furthermore, the protrusions 98 and the recesses 100 may alternate about the rotational axis R.

The bushing 90 may comprise a flange 102 having an annular configuration and extending radially away from the rotational axis R. The flange 102 of the bushing 90 may have the one (or more) of the plurality of protrusions 98 and may define the one (or more) of the plurality of recesses 100. Furthermore, the bushing 90 may define a first surface 104 transverse to the rotational axis R and the gear body 82 may define a second surface 106 transverse to the rotational axis R and opposing the first surface 104, as shown in FIGS. 5 and 12. More specifically, the flange 102 may present the first surface 104. The second surface 106 of the gear body 82 may at least partially define a channel 108 having an annular configuration about the rotational axis R and opening into the bore 86. The flange 102 may extend into the channel 108 with the first and second surfaces 104, 106 abutting one another. The abutment of the first and second surfaces 104, 106 may fix together the gear body 82 and the bushing 90 along the rotational axis R. Said differently, the first and second surfaces 104, 106 may prevent the bushing 90 from being pushed out of the bore 86 of the gear body 82 due to loading of gear 80 along the rotational axis R.

As shown in FIGS. 5 and 12, the gear body 82 may define a second bore 110 along and about a second axis S spaced from and parallel to the rotational axis R and configured to receive a second pin 112 facilitating eccentric motion. More specifically, the second bore 110 and the second pin 112 may each have corresponding substantially cylindrical configurations. The second pin 112 may be frictionally engage the gear body 82 within the second bore 110 such that the second pin 112 is fixed to the gear body 82. However, the second bore 110 and the second pin 112 may have any suitable configuration to receive the second pin 112 in the second bore 110.

The bearing 56 may be coupled to the second pin 112 and may be rotatable about the second axis S. As shown in FIG. 3, the output shaft 36 may be coupled to the bearing 56 (e.g., by press-fitting). The bearing 56 facilitates movement of the output shaft 36. Rotation of the gear assembly 78 about the rotational axis R results in linear motion of the output shaft 36.

As shown in FIG. 5, the gear body 82 may comprise a wall 114 separating the bore 86 and the second bore 110. The wall 114 may have a maximum thickness T of five millimeters. The overmolding of the bushing 90 and the gear body 82 facilitates producing the wall 114 with such a small thickness T. More specifically, if the bushing 90 was inserted into the bore 86 (e.g. press-fitting), the bushing 90 would have an exterior diameter equal to or greater than the bore 86 to ensure a friction fit therebetween to fix the bushing 90 to the gear 80. Insertion of the bushing 90 into the bore 86 would exert lateral forces on the wall 114 outwardly from the rotational axis R. If the wall 114 were to have a small thickness like the thickness T comprehended in the present invention, the wall 114 would deflect and/or buckle under the force of insertion.

In another embodiment shown in FIG. 12, the gear body 82 defines a cavity 116 extending radially away from and opening into the second bore 110. The gear assembly 78 may further comprise a shaft assembly 118 (rather than the second pin 112) having a plate 120 disposed within second bore 110 and a shaft 122 disposed within the second bore 110. Similar to the second pin 112, the shaft 122 extends along the second axis S. The bearing 56 may be coupled to the shaft 122 and may be rotatable about the second axis S.

As shown in FIG. 12, the cavity 116 may be sized and shaped to encapsulate the plate 120 (i.e., the gear body 82 lies directly against the plate 120 without voids around the plate 120). To facilitate encapsulating the plate 120, the gear 80 may be overmolded around the shaft assembly 118. As shown in FIGS. 12-14, the shaft 122 and the plate 120 are integral and comprised of metallic material. However, the shaft 122 and plate 120 may be separate components coupled to one another and may be comprised of any suitable material. Furthermore, the plate 120 may be disposed in the cavity 116 of the gear body 82 in any suitable manner.

The plate 120 imparts additional structural rigidity to the gear 80 to prevent deflection of the gear 80 under load. Furthermore, the plate 120 increases the amount of surface area in contact with the gear body 82 of the gear 80 as compared to the second pin 112, which increases the friction between the shaft assembly 118 and the gear 80 to prevent rotation of the shaft 122 relative to the gear 80.

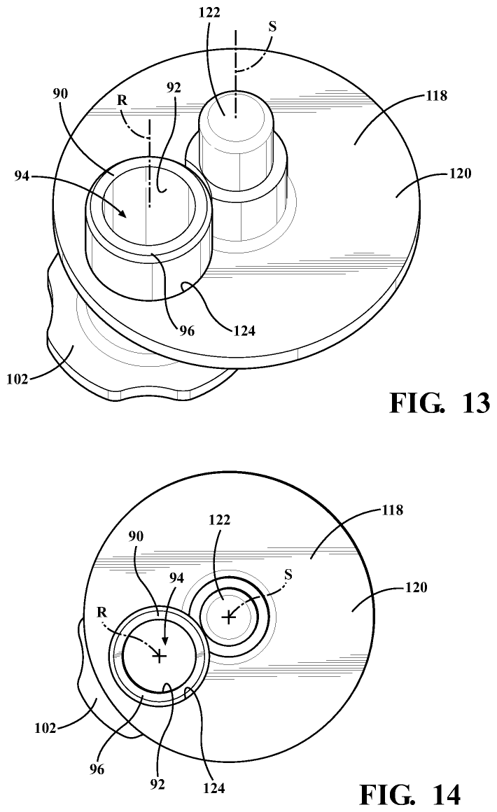

As shown in FIGS. 13 and 14, the plate 120 may have a substantially planar, disk-shaped configuration. However, one having skill in the art will appreciate that the plate 120 may have any suitable size, shape, and configuration.

The shaft assembly 118 may facilitate positioning the shaft 122 in contact with the bushing 90 reduce the eccentric radius between the rotational axis R that gear assembly 78 rotates about and the second axis S that the bearing 56 is rotatable about. Because the gear 80 may be overmolded to the shaft assembly 118 and the second pin 112 is not inserted into the gear 80, the wall 114 of the gear body 82 may not be necessary. Furthermore, positioning the shaft 122 in contact with the bushing 90 eliminates the wall 114, as shown in FIG. 12. However, the shaft 122 may be spaced any suitable distance from the bushing 90 and the wall 114 (having any suitable thickness T) may be disposed between the shaft 122 and the bushing 90.

The cavity 116 may open into the bore 86 and the plate 120 may define an aperture 124 concentrically aligned with the bore 86. The bushing 90 may extend through the aperture 124, as shown in FIGS. 12-14. Accordingly, the aperture 124 prevents contact between the pin 76 and the plate 120 and positions the bushing 90 relative to the shaft 122. The location of the aperture 124 relative to the shaft 122 may vary according to design in order to produce the desired eccentric radius between the rotational axis R and the second axis S.

The present invention has been described in an illustrative manner. It is to be understood that the terminology which has been used is intended to be in the nature of words of description rather than of limitation. As is now apparent to those skilled in the art, many modifications and variations of the subject invention are possible in light of the above teachings.

It is, therefore, to be understood that within the scope of the appended claims, wherein reference numerals are merely for convenience and are not to be in any way limiting, the present invention may be practiced otherwise than as specifically described.

What is claimed is:

1. A gear assembly for rotation about a pin in an actuator, said gear assembly comprising:
a gear comprising:
a gear body comprising a first polymer surrounding and extending radially away from a rotational axis, with said gear body having an internal surface defining a bore along and about said rotational axis; and
a plurality of teeth extending from said gear body; and
a bushing comprising a second polymer, different than said first polymer, with said bushing disposed within said bore and one of said bushing and said gear body overmolded to the other one of said bushing and said gear body along said internal surface, and with said bushing having a bearing surface defining a hole along and about said rotational axis for rotatably engaging said bearing surface with the pin in said hole.

2. The gear assembly as set forth in claim 1, wherein one of said gear body and said bushing has a protrusion extending radial to said rotational axis and the other one of said gear body and said bushing defines a recess configured to receive said protrusion to rotationally retain together said gear body and said bushing about said rotational axis.

3. The gear assembly as set forth in claim 2, wherein said protrusion has a convex arcuate configuration and said recess has a corresponding concave arcuate configuration.

4. The gear assembly as set forth in claim 2, wherein said protrusion is further defined as a plurality of protrusions and said recess is further defined as a plurality of recesses individually corresponding with said plurality of protrusions.

5. The gear assembly as set forth in claim 4, wherein said protrusions and said recesses alternate about said rotational axis.

6. The gear assembly as set forth in claim 4, wherein each of said gear body and said bushing has one of said plurality of protrusions radially spaced about said rotational axis and each of said gear body and said bushing defines one of said plurality of said recesses radially spaced about said rotational axis, with said recess of said bushing configured to receive said protrusion of said gear body and said recess of said gear body configured to receive said protrusion.

7. The gear assembly as set forth in claim 6, wherein said bushing comprises a flange having an annular configuration and extending radially away from said rotational axis, with said flange of said bushing has said one of said plurality of protrusions and defines said one of said plurality of recesses.

8. The gear assembly as set forth in claim 1, wherein said bushing defines a first surface transverse to said rotational axis and said gear body defines a second surface transverse to said rotational axis and opposing said first surface, with said first and second surfaces configured to abut one another and to fix together said gear body and said bushing along said rotational axis.

9. The gear assembly as set forth in claim 8, wherein said bushing comprises a flange having an annular configuration and extending radially away from said rotational axis to present said first surface.

10. The gear assembly as set forth in claim 9, wherein said second surface of said gear body at least partially defining a channel having an annular configuration about said rotational axis and opening into said bore, with said flange extending into said channel with said first and second surfaces abutting one another.

11. The gear assembly as set forth in claim 1, wherein said bushing comprises a wear region between said bearing surface and said internal surface of said gear body, with said wear region comprises only said second polymer to facilitate even wear of the bushing as said gear assembly rotates about the pin.

12. The gear assembly as set forth in claim 1, wherein said gear body defines a second bore along and about a second axis spaced from and parallel to said rotational axis and configured to receive a second pin facilitating eccentric motion.

13. The gear assembly as set forth in claim 12, wherein said gear body comprises a wall separating said bore and said second bore and having a maximum thickness of five millimeters.

14. The gear assembly as set forth in claim 12, wherein said gear body defines a cavity extending radially away from and opening into said second bore.

15. The gear assembly as set forth in claim 14, further comprising a shaft assembly having a plate disposed within second bore and a shaft disposed within said second bore.

16. The gear assembly as set forth in claim 15, wherein said cavity opens into said bore and said plate defines an aperture concentrically aligned with said bore, with said bushing extending through said aperture.

17. The gear assembly as set forth in claim 1, wherein said plurality of teeth extend radially away from said rotational axis.

18. The gear assembly as set forth in claim 1, further comprising a glass fiber dispersed within said first polymer.

19. The gear assembly as set forth in claim 1, wherein said first polymer comprises a polyamide.

20. A gear assembly for rotation about a pin in an actuator, said gear assembly comprising:
a gear comprising:
a gear body comprising a first polymer surrounding and extending radially away from a rotational axis, with said gear body having an internal surface defining a bore along and about said rotational axis; and
a plurality of teeth extending from said gear body; and
a bushing comprising a second polymer, different than said first polymer, with said bushing disposed within said bore and one of said bushing and said gear body overmolded to the other one of said bushing and said gear body along said internal surface, and with said bushing having a bearing surface defining a hole along and about said rotational axis for rotatably engaging said bearing surface with the pin in said hole;
wherein one of said gear body and said bushing has a protrusion extending radial to said rotational axis and the other one of said gear body and said bushing defines a recess configured to receive said protrusion to rotationally retain together said gear body and said bushing about said rotational axis; and
wherein said bushing defines a first surface transverse to said rotational axis and said gear body defines a second surface transverse to said rotational axis and opposing said first surface, with said first and second surfaces configured to abut one another and to fix together said gear body and said bushing along said rotational axis.

21. A gear drive assembly for use with and driven by a motor in an actuator, said gear drive assembly comprising:
a housing defining a cavity; and
a pin disposed in said cavity and coupled to said housing; and
a gear assembly rotatable about said pin, said gear assembly comprising:
a gear comprising:
a gear body comprising a first polymer surrounding and extending radially away from a rotational axis, with said gear body having an internal surface defining a bore along and about said rotational axis; and
a plurality of teeth extending from said gear body; and
a bushing comprising a second polymer, different than said first polymer, with said bushing disposed within said bore and one of said bushing and said gear body overmolded to the other one of said bushing and said gear body along said internal surface, and with said bushing having a bearing surface defining a hole along and about said rotational axis for rotatably engaging said bearing surface with the pin in said hole.
